(19) United States
(12) Patent Application Publication
(10) Pub. No.: US 2011/0221820 A1
(43) Pub. Date: Sep. 15, 2011

(54) METHOD OF CALIBRATING TEMPERATURE SENSOR, METHOD OF MANUFACTURING RECORDING HEAD, AND INKJET RECORDING APPARATUS

(76) Inventor: Hiroshi SHIBATA, Kanagawa-ken (JP)

(21) Appl. No.: 13/042,769

(22) Filed: Mar. 8, 2011

(30) Foreign Application Priority Data
Mar. 9, 2010 (JP) 2010-051841

(51) Int. Cl. B41J 29/38; B23P 17/00

(52) U.S. Cl. 347/17; 29/890.1

(57) ABSTRACT

A method of calibrating a temperature sensor, provided in the recording head, for measuring a temperature of a liquid in a recording head of an inkjet type having nozzles from which the liquid is ejected, includes: an ambient temperature acquisition step of acquiring an ambient temperature where the recording head is located; a sensor output value acquisition step of acquiring an output value of the temperature sensor in a state where the liquid has been filled into the recording head; a calculation step of calculating a correction coefficient for correcting the output value according to the ambient temperature and the output value; and a storage step of storing the correction coefficient in a storage device of the recording head.

### BACKGROUND OF THE INVENTION

1. Field of the Invention

The present invention relates to a method of calibrating a temperature sensor, a method of manufacturing a recording head, and an inkjet recording apparatus, and more particularly to technology for calibrating a temperature sensor provided in a recording head in order to measure the temperature of ink.

2. Description of the Related Art

The viscosity of the ink used in an inkjet recording apparatus changes with temperature. Therefore, if the temperature of the ink supplied to a recording head varies, then the ink ejection characteristics also vary due to the change in the viscosity of the ink. For example, if the temperature of the ink falls, then the viscosity of the ink rises, leading to decrease in the ink ejection volume and decline in the flight speed. Therefore, it is sought to stabilize the ejection characteristics of the recording head by adjusting the temperature of the ink before supplying the ink to the recording head.

Japanese Patent Application Publication No. 7-256894 discloses an inkjet recording apparatus including a determination device, mounted on an inkjet head, which determines the temperature of the inkjet head, and a determination device, mounted on an inkjet recording apparatus, which determines the ambient temperature, wherein a correction device is provided to correct the value from the determination device which determines the temperature of the inkjet head, on the basis of the value from the determination device which determines the ambient temperature.

By means of this technology, it is possible to determine the temperature of the inkjet head accurately, even if there is manufacturing variation in the temperature sensor which determines the temperature of the inkjet head. Furthermore, even if a new inkjet head is installed, since a correction operation is carried out accordingly, it is also possible to determine variation in the temperature sensor in the inkjet head, automatically.

However, according to the technology described in Japanese Patent Application Publication No. 7-256894, if the inkjet head is large, as in a line head, or the like, then a temperature distribution arises inside the head and therefore the ambient temperature and the head temperature are different and the calibration accuracy may decline.

Furthermore, when replacing a head, the storage condition of the new head is not known, and hence there has been a possibility of the calibration accuracy declining if calibration is performed before the temperature, and the like, of the head has become stable after replacement. On the other hand, if the temperature, and the like, of the head after replacement takes time to stabilize, then it takes time until the next printing operation can be carried out.

### SUMMARY OF THE INVENTION

The present invention has been contrived in view of these circumstances, an object thereof being to provide a method of calibrating a temperature sensor which improves the accuracy of calibration of a temperature sensor, as well as shortening the start-up time of an apparatus after head replacement, and to provide a method of manufacturing a recording head and an image recording apparatus.

In order to attain an object described above, one aspect of the present invention is directed to a method of calibrating a temperature sensor for measuring a temperature of a liquid in a recording head of an inkjet type having nozzles from which the liquid is ejected, the temperature sensor being provided in the recording head, the method comprising: an ambient temperature acquisition step of acquiring an ambient temperature where the recording head is located; a sensor output value acquisition step of acquiring an output value of the temperature sensor in a state where the liquid has been filled into the recording head; a calculation step of calculating a correction coefficient for correcting the output value according to the ambient temperature and the output value; and a storage step of storing the correction coefficient in a storage device of the recording head.

According to this aspect of the invention, a correction coefficient for correcting the output value is calculated according to the ambient temperature and the output value of the temperature sensor, and the correction coefficient thus calculated is stored in a storage device of the recording head. Therefore, it is possible to correct the output value of the temperature sensor by reading out the correction coefficient stored in the storage device, and the calibration accuracy of the temperature sensor is improved, as well as being able to shorten the start-up time of the apparatus after head replacement.

Desirably, in the sensor output value acquisition step, the output value of the temperature sensor is acquired in a state where ejection of the liquid is not being performed by the recording head.

According to this aspect of the invention, it is possible to calculate a suitable correction coefficient.

Desirably, the recording head includes a circulation flow channel for circulating the liquid, and in the sensor output value acquisition step, the output value of the temperature to sensor is acquired in a state where the liquid is not being circulated in the circulation flow channel.

According to this aspect of the invention, it is possible to calculate a suitable correction coefficient.

In order to attain an object described above, another aspect of the present invention is directed to an ink jet recording apparatus comprising: a recording head of an inkjet type which includes nozzles from which a liquid is ejected and a temperature sensor for measuring a temperature of the liquid in the recording head; an introduction device which introduces the liquid into the recording head; a reservoir which connects with the introduction device via a liquid flow channel; a liquid conveyance device which supplies the liquid from the reservoir to the recording head; an ambient temperature acquisition device which acquires an ambient temperature where the recording head is located; a sensor output value acquisition device which acquires an output value of the temperature sensor in a state where the liquid has been filled into the recording head; a calculation device which calculates a correction coefficient for correcting the output value according to the ambient temperature and the output value; a liquid temperature measurement device which acquires the output value of the temperature sensor and corrects the acquired output value according to the correction coefficient to calculate the temperature of the liquid in the recording head; and a control device which controls the recoding head to cause the liquid to be ejected from the nozzles.

According to this aspect of the invention, since a correction coefficient for correcting the output value of the temperature sensor is calculated according to the ambient temperature and the output value, and the acquired output value is corrected according to the correction coefficient so as to calculate the temperature of the liquid inside the recording head, then it is possible to measure the temperature of the liquid in the recording head, accurately.

Desirably, the inkjet recording apparatus further comprises a storage device which stores the correction coefficient, wherein when the control device causes the liquid to be ejected from the nozzles, the correction coefficient is stored previously in the storage device.

According to this aspect of the invention, it is possible to shorten the start-up time of the apparatus after head replacement, by using a previously stored correction coefficient.

Desirably, the inkjet recording apparatus further comprises a judgment device which judges whether or not a temperature distribution of the liquid in the recording head is normal, wherein: the recording head has the plurality of temperature sensors, the liquid temperature measurement device calculates the temperature distribution of the liquid in the recording head according to the plurality of temperature sensors, and the judgment device which judges whether or not the temperature distribution is normal, according to the temperature distribution calculated by the liquid temperature measurement device.

According to this aspect of the invention, it is possible to determine abnormality of the temperature distribution inside the recording head.

Desirably, the inkjet recording apparatus further comprises a temperature control device which controls the temperature of the liquid, wherein: the recording head includes a plurality of modules each having the nozzles, the plurality of temperature sensors are provided for the plurality of modules respectively, and the temperature control device controls the temperature of the liquid with respect to each of the plurality of modules, according to the temperature of the liquid in each of the plurality of modules obtained from the plurality of temperature sensors provided for the plurality of modules respectively.

According to this aspect of the invention, it is possible to reduce temperature distribution inside the recording head.

Desirably, the introduction device includes individual flow channels which introduce the liquid into the plurality of modules respectively, and the temperature control device is a temperature adjustment device which heats and/or cools the liquid in the individual flow channels.

According to this aspect of the invention, it is possible to adjust the temperature for each of the modules, and the temperature distribution inside the recording head can be reduced.

Desirably, the introduction device includes individual flow channels which introduce the liquid into the plurality of modules respectively and electromagnetic valves provided for the individual flow channels respectively, and the temperature control device is an electromagnetic valve control device which causes the electromagnetic valves to heat the liquid.

According to this aspect of the invention, it is possible to adjust the temperature for each of the modules, and the temperature distribution inside the recording head can be reduced.

Desirably, the introduction device includes individual flow channels which introduce the liquid into the plurality of modules respectively and a flow rate control device capable of controlling a flow rate of the liquid for each of the individual flow channels, and the temperature control device causes the flow rate control device to control the flow rate of the liquid to makes the temperature distribution in each of the plurality of modules uniform.

According to this aspect of the invention, it is possible to adjust the temperature for each of the modules, and the temperature distribution inside the recording head can be reduced.

Desirably, the inkjet recording apparatus further comprises an ejection rate modification device which modifies an ejection rate of the liquid from the nozzles, wherein: the recording head includes a plurality of modules each having the nozzles, and the temperature sensors provided for the plurality of modules respectively, and the ejection rate modification device modifies the ejection rate of the liquid from the nozzles with respect to each of the plurality of modules, according to the temperature of the liquid obtained from the temperature sensors provided for the plurality of modules respectively.

According to this aspect of the invention, it is possible to maintain print quality, even if there is a temperature distribution inside the head.

Desirably, the inkjet recording apparatus further comprises a drive signal generation device which generates a drive signal for ejecting the liquid from the nozzles, wherein the ejection rate modification device modifies the drive signal with respect to each of the plurality of modules to modify the ejection rate, according to the temperature of the liquid obtained from the temperature sensors.

According to this aspect of the invention, it is possible to change the ejection rate for each of the modules, in an appropriate fashion.

In order to attain an object described above, another aspect of the present invention is directed to a method of manufacturing a recording head of an inkjet type including nozzles from which a liquid is ejected and a temperature sensor for measuring a temperature of the liquid in the recording head, the method comprising: an ambient temperature acquisition step of acquiring an ambient temperature where the recording head is located; a sensor output value acquisition step of acquiring an output value of the temperature sensor in a state where the liquid has been filled into the recording head; a calculation step of calculating a correction coefficient for correcting the output value according to the ambient temperature and the output value; and a storage step of storing the correction coefficient in a storage device of the recording head.

According to this aspect of the invention, it is possible to manufacture a recording head with improved calibration accuracy of an in-built temperature sensor, as well as being able to shorten the start-up time of an apparatus upon replacing the recording head in a recording apparatus which uses the recording head.

According to the present invention, the calibration accuracy of the temperature sensor can be raised and furthermore the start-up time of the apparatus upon replacing the head can be shortened.

### BRIEF DESCRIPTION OF THE DRAWINGS

A preferred embodiment of this invention as well as other objects and benefits thereof, will be explained in the following with reference to the accompanying drawings, in which like reference characters designate the same or similar parts throughout the figures and wherein:

FIG. 1 is a general schematic drawing showing an example of the composition of an inkjet recording apparatus;

FIGS. 2A to 2C are plan view perspective diagrams showing an example of the structure of a print head;

FIG. 3 is a cross-sectional diagram showing the composition of an ink chamber unit;

FIG. 4 is a flow channel schematic drawing showing the structure of flow channels inside a head;

FIG. 5 is a schematic drawing showing the composition of an ink supply system of an inkjet recording apparatus;

FIG. 6 is a principal block diagram showing the control system of an inkjet recording apparatus;

FIG. 7 is a flowchart showing a calibration process for a head temperature sensor;

FIG. 8 is a graph showing the relationship between the internal state of the head and the temperature variation after calibration;

FIG. 9 is a graph showing variation in the measurement temperature before and after calibration of a temperature sensor;

FIG. 10 is a schematic drawing showing the composition of an ink supply system including individual temperature adjustment units;

FIG. 11 is a schematic drawing showing the composition of an ink supply system including electromagnetic valves;

FIGS. 12A to 12C are waveform diagrams showing one example of current applied to an electromagnetic valve; and

FIGS. 13A to 13C are waveform diagrams showing a further example of the control current applied to an electromagnetic valve.

### DESCRIPTION OF THE PREFERRED EMBODIMENTS

### Example of Composition of Inkjet Recording Apparatus

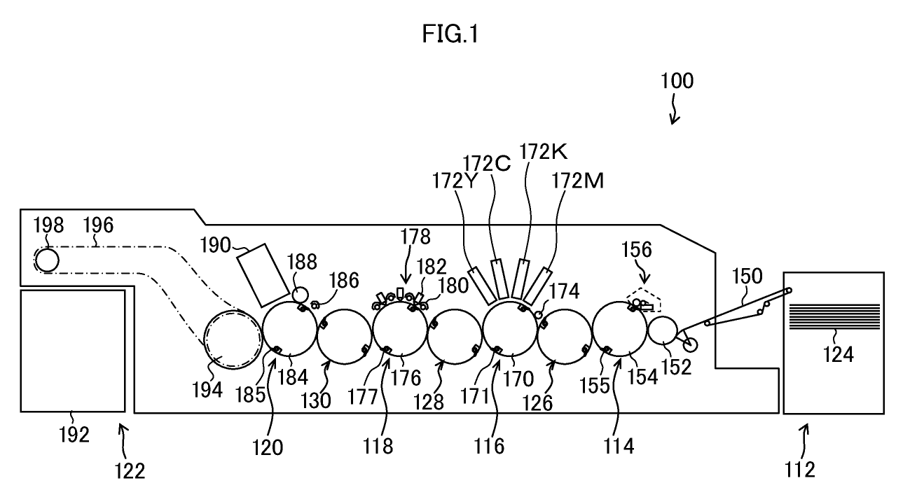

FIG. 1 is a general schematic drawing showing an example of the composition of an inkjet recording apparatus relating to an embodiment of the present invention. As shown in FIG. 1, an inkjet recording apparatus 100 according to the present embodiment is principally includes a paper supply unit 112, a treatment liquid deposition unit (pre-coating unit) 114, an image formation unit 116, a drying unit 118, a fixing unit 120 and a paper output unit 122.

The inkjet recording apparatus 100 is an inkjet recording apparatus using a single pass method, which forms a desired color image by ejecting droplets of inks of a plurality of colors from long inkjet heads 172M, 172K, 172C and 172Y onto a recording medium 124 (called “paper” below for the sake of convenience) held on a pressure drum (image formation drum 170) of an image formation unit 116. The inkjet recording apparatus 100 is an image forming apparatus of an on-demand type employing a two-liquid reaction (aggregation) method in which an image is formed on a recording medium 124 by depositing a treatment liquid (here, an aggregating treatment liquid) on the recording medium 124 before ejecting droplets of ink, and causing the treatment liquid and ink liquid to react together.

### Paper Supply Unit

Cut sheet recording media 124 are stacked in the paper supply unit 112 and a recording medium 124 is supplied, one sheet at a time, to the treatment liquid deposition unit 114, from a paper supply tray 150 of the paper supply unit 112. As the recording medium 124, it is possible to use recording media 124 of a plurality of types having different materials and dimensions (paper size). It is also possible to use a mode in which a plurality of paper trays (not illustrated) for respectively and separately stacking recording media of different types are provided in the paper supply unit 112, and the paper sent to the paper supply tray 150 amongst this plurality of paper trays is switched automatically, or a mode in which the operator selects the paper tray or replaces the paper tray according to requirements. In the present embodiment, cut sheet paper (cut paper) is used as the recording medium 124, but it is also possible to adopt a composition in which paper is supplied from a continuous roll (rolled paper) and is cut to the required size.

### Treatment Liquid Deposition Unit

The treatment liquid deposition unit 114 has a mechanism which deposits treatment liquid onto a recording surface of the recording medium 124. The treatment liquid includes a coloring material aggregating agent which aggregates the coloring material (in the present embodiment, the pigment) in the ink deposited by the image formation unit 116, and the separation of the ink into the coloring material and the solvent is promoted due to the treatment liquid and the ink making contact with each other.

The treatment liquid deposition unit 114 includes a paper supply drum 152, a treatment liquid drum (also called a “pre-coating drum”) 154 and a treatment liquid application apparatus 156. The treatment liquid drum 154 is a drum which holds the recording medium 124 and conveys the medium to rotate. The treatment liquid drum 154 includes a hook-shaped gripping device (gripper) 155 provided on the outer circumferential surface thereof, and is devised in such a manner that the leading end of the recording medium 124 can be held by gripping the recording medium 124 between the hook of the holding device 155 and the circumferential surface of the treatment liquid drum 154. The treatment liquid drum 154 may include suction holes provided in the outer circumferential surface thereof, and be connected to a suctioning device which performs suctioning via the suction holes. By this means, it is possible to hold the recording medium 124 tightly against the circumferential surface of the treatment liquid drum 154.

A treatment liquid application apparatus 156 is provided opposing the circumferential surface of the treatment liquid drum 154, to the outside of the drum. The treatment liquid application apparatus 156 includes a treatment liquid vessel in which treatment liquid is stored, an anilox roller which is partially immersed in the treatment liquid in the treatment liquid vessel, and a rubber roller which transfers a dosed amount of the treatment liquid to the recording medium 124, by being pressed against the anilox roller and the recording medium 124 on the treatment liquid drum 154. According to this treatment liquid application apparatus 156, it is possible to apply treatment liquid to the recording medium 124 while dosing the amount of the treatment liquid.

In the present embodiment, a composition is described which uses a roller-based application method, but the method is not limited to this, and it is also possible to employ various other methods, such as a spray method, an inkjet method, and the like.

The recording medium 124 onto which the treatment liquid has been deposited by the treatment liquid deposition unit 114 is transferred from the treatment liquid drum 154 to the image formation drum 170 of the image formation unit 116 via the intermediate conveyance unit 126.

### Image Formation Unit

The image formation unit 116 includes an image formation drum (also called “jetting drum”) 170, a paper pressing roller 174, and inkjet heads 172M, 172K, 172C and 172Y Similarly to the treatment liquid drum 154, the image formation drum 170 includes a hook-shaped holding device (gripper) 171 on the outer circumferential surface of the drum. The recording medium 124 held on the image formation drum 170 is conveyed with the recording surface thereof facing to the outer side, and ink is deposited onto this recording surface from the inkjet heads 172M, 172K, 172C and 172Y.

The inkjet heads 172M, 172K, 172C and 172Y are each full-line type inkjet recording heads (inkjet heads) having a length corresponding to the maximum width of the image forming region on the recording medium 124, and rows of nozzles (a two-dimensional nozzle arrangement) for ejecting ink arranged throughout the whole width of the image forming region are formed in the ink ejection surface of each head. The inkjet heads 172M, 172K, 172C and 172Y are disposed so as to extend in a direction perpendicular to the conveyance direction of the recording medium 124 (the direction of rotation of the image formation drum 170).

The ejection timings of the inkjet heads 172M, 172K, 172C and 172Y are synchronized with an encoder (not illustrated) which determines the speed of rotation and is positioned on the image formation drum 170. By this means, it is possible to specify the depositing position with high accuracy.

When droplets of the corresponding colored ink are ejected from the inkjet heads 172M, 172K, 172C and 172Y toward the recording surface of the recording medium 124 which is held tightly on the image formation drum 170, the ink makes contact with the treatment liquid which has previously been deposited onto the recording surface by the treatment liquid deposition unit 114, the coloring material (pigment) dispersed in the ink is aggregated, and a coloring material aggregate is thereby formed. By this means, flowing of coloring material, and the like, on the recording medium 124 is prevented and an image is formed on the recording surface of the recording medium 124.

Although the configuration with the CMYK four standard colors is described in the present embodiment, combinations of the ink colors and the number of colors are not limited to those. Light inks, dark inks or special color inks can be added as required. For example, a configuration is possible in which inkjet heads for ejecting light-colored inks such as light cyan and light magenta are added. Furthermore, there are no particular restrictions of the sequence in which the heads of respective colors are arranged.

The recording medium 124 onto which an image has been formed in the image formation unit 116 is transferred from the image formation drum 170 to the drying drum 176 of the drying unit 118 via the intermediate conveyance unit 128.

### Drying Unit

The drying unit 118 is a mechanism which dries the water content contained in the solvent which has been separated by the action of aggregating the coloring material, and as shown in FIG. 1, includes a drying drum 176 and a solvent drying apparatus 178. Similarly to the treatment liquid drum 154, the drying drum 176 includes a hook-shaped holding device (gripper) 177 provided on the outer circumferential surface of the drum in such a manner that the leading end of the recording medium 124 can be held by the holding device 177.

The solvent drying apparatus 178 is disposed in a position opposing the outer circumferential surface of the drying drum 176, and is constituted by a plurality of halogen heaters 180 and hot air spraying nozzles 182 disposed respectively between the halogen heaters 180.

It is possible to achieve various drying conditions, by suitably adjusting the temperature and air flow volume of the hot air flow which is blown from the hot air flow spraying nozzles 182 toward the recording medium 124, and the temperatures of the respective halogen heaters 180.

Furthermore, the surface temperature of the drying drum 176 is set to 50° C. or above. By heating from the rear surface of the recording medium 124, drying is promoted and breaking of the image during fixing can be prevented. There are no particular restrictions on the upper limit of the surface temperature of the drying drum 176, but from the viewpoint of the safety of maintenance operations such as cleaning the ink adhering to the surface of the drying drum 176 (namely, preventing burns due to high temperature), desirably, the surface temperature of the drying drum 76 is equal to or lower than 75° C. (and more desirably, equal to or lower than 60° C.).

By holding the recording medium 124 in such a manner that the recording surface thereof is facing outwards on the outer circumferential surface of the drying drum 176 (in other words, in a state where the recording surface of the recording medium 124 is curved in a convex shape), and drying while conveying the recording medium in rotation, it is possible to prevent the occurrence of wrinkles or floating up of the recording medium 124, and therefore drying non-uniformities caused by these phenomena can be prevented reliably.

The recording medium 124 on which a drying process has been carried out in the drying unit 118 is transferred from the drying drum 176 to the fixing drum 184 of the fixing unit 120 via the intermediate conveyance unit 130.

### Fixing Unit

The fixing unit 120 includes a fixing drum 184, a halogen heater 186, a fixing roller 188 and an in-line sensor 190. Similarly to the treatment liquid drum 154, the fixing drum 184 includes a hook-shaped holding device (gripper) 185 provided on the outer circumferential surface of the drum, in such a manner that the leading end of the recording medium 124 can be held by the holding device 185.

By means of the rotation of the fixing drum 184, the recording medium 124 is conveyed with the recording surface facing to the outer side, and preliminary heating by the halogen heater 186, a fixing process by the fixing roller 188 and inspection by the in-line sensor 190 are carried out in respect of the recording surface.

The halogen heater 186 is controlled to a prescribed temperature (for example, 180° C.). By this means, preliminary heating of the recording medium 124 is carried out.

The fixing roller 188 is a roller member for applying heat and pressure to the dried ink so as to melt self-dispersing polymer micro-particles contained in the ink and thereby causing the ink to form a film, and is composed so as to heat and pressurize the recording medium 124. More specifically, the fixing roller 188 serves as a nip roller with respect to the fixing drum 184, and is disposed so as to press against the fixing drum 184 in such a manner that a nip is created between the fixing roller and the fixing drum 184. By this means, the recording medium 124 is sandwiched between the fixing roller 188 and the fixing drum 184 and is nipped with a prescribed nip pressure (for example, 0.15 MPa), whereby a fixing process is carried out.

Furthermore, the fixing roller 188 is constituted by a heated roller where a metal pipe of aluminum, or the like, having good thermal conductivity, internally incorporates a halogen lamp, and is controlled to a prescribed temperature (for example, 60° C. to 80° C.). By heating the recording medium 124 by means of this heating roller, thermal energy equal to or greater than the Tg temperature (glass transition temperature) of the latex contained in the ink is applied and the latex particles are thereby caused to melt. By this means, fixing is performed by pressing the latex particles into the undulations in the recording medium 124, as well as leveling the undulations in the image surface and obtaining a glossy finish.

In the embodiment shown in FIG. 1, only one fixing roller 188 is provided, but it is also possible to provide fixing rollers in a plurality of stages, in accordance with the thickness of the image layer and the Tg characteristics of the latex particles.

On the other hand, the in-line sensor 190 is a measurement device for measuring an ejection defect checking pattern, the amount of moisture, the surface temperature, the glossiness, and the like, of the image (including a test pattern, and the like) which has been recorded on the recording medium 124; a CCD line sensor, or the like, is employed for the in-line sensor 190.

According to the fixing unit 120 having the composition described above, the latex particles in the thin image layer formed by the drying unit 118 are heated, pressurized and melted by the fixing roller 188, and hence the image layer can be fixed to the recording medium 124. Furthermore, the surface temperature of the fixing drum 184 is set to 50° C. or above. Drying is promoted by heating the recording medium 124 held on the outer circumferential surface of the fixing drum 184 from the rear surface, and therefore breaking of the image during fixing can be prevented, and furthermore, the strength of the image can be increased by the effects of the increased temperature of the image.

Instead of an ink which includes a high-boiling-point solvent and polymer micro-particles (thermoplastic resin particles), it is also possible to include a monomer which can be polymerized and cured by exposure to UV light. In this case, the inkjet recording apparatus 100 includes a UV exposure unit for exposing the ink on the recording medium 124 to UV light, instead of a heat and pressure fixing unit (fixing roller 188) based on a heat roller. In this way, if using an ink containing an active light-curable resin, such as an ultraviolet-curable resin, a device which irradiates the active light, such as a UV lamp or an ultraviolet LD (laser diode) array, is provided instead of the fixing roller 188 for heat fixing.

### Paper Output Unit

As shown in FIG. 1, a paper output unit 122 is provided subsequently to the fixing unit 120. The paper output unit 122 includes an output tray 192, and a transfer drum 194, a conveyance belt 196 and a tensioning roller 198 are provided between the output tray 192 and the fixing drum 184 of the fixing unit 120 so as to oppose same. The recording medium 124 is sent to the conveyance belt 196 by the transfer drum 194 and output to the output tray 192. The details of the paper conveyance mechanism created by the conveyance belt 196 are not shown, but the leading end portion of a recording medium 124 after printing is held by a gripper on a bar (not illustrated) which spans on the endless conveyance belt 196, and the recording medium is conveyed above the output tray 192 due to the rotation of the conveyance belts 196.

Furthermore, although not shown in FIG. 1, the inkjet recording apparatus 100 according to the present embodiment includes, in addition to the composition described above, an ink storing and loading unit which supplies ink to the inkjet heads 172M, 172K, 172C and 172Y, and a device which supplies treatment liquid to the treatment liquid deposition unit 114, as well as including a head maintenance unit which carries out cleaning (nozzle surface wiping, purging, nozzle suctioning, and the like) of the inkjet heads 172M, 172K, 172C and 172Y, a position determination sensor which determines the position of the recording medium 124 in the paper conveyance path, and temperature sensors which determines the temperature of the respective units of the apparatus, and the like.

### Structure of the Ink Jet Head

Next, the structure of the heads 172K, 172C, 172M and 172Y will be described. Since the heads 172K, 172C, 172M and 172Y have the same structure, a reference numeral 50 is hereinafter designated to any of the heads.

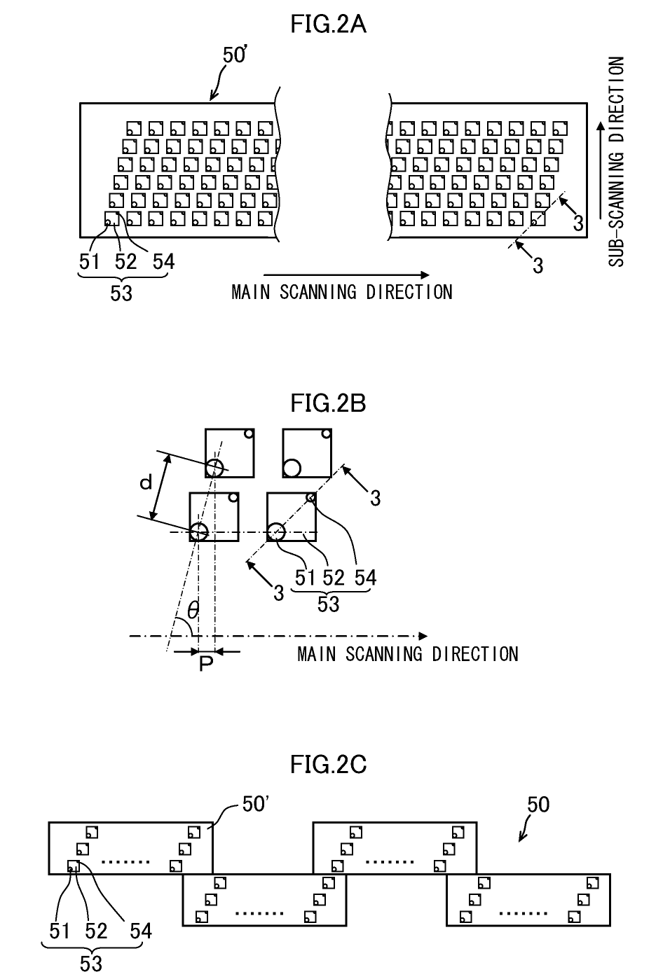

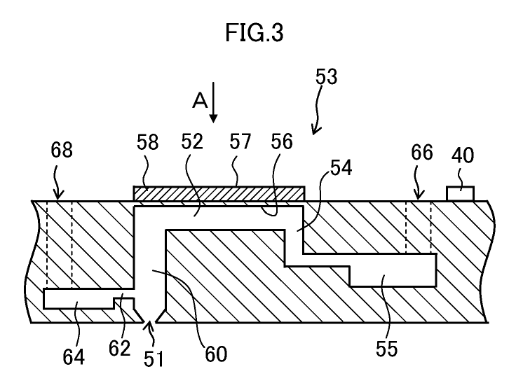

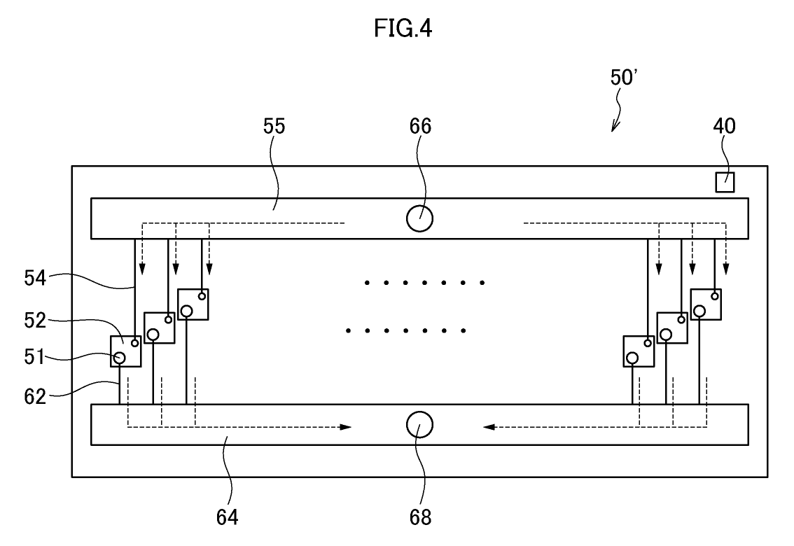

FIG. 2A is a perspective plan diagram showing an example of the configuration of a head module 50′ (head chip) constituting the head 50, FIG. 2B is an enlarged diagram of a portion thereof, FIG. 2C is a perspective plan diagram showing an example of the configuration of the entire head 50. Further, FIG. 3 is a cross-sectional diagram showing the composition of an ink chamber unit (cross-sectional diagram taken along the line 3-3 in FIGS. 2A and 2B), and FIG. 4 is a flow channel schematic diagram (perspective diagram seen from the A direction in FIG. 3) showing the inner structure of the head module 50′.

The nozzle pitch in the head 50 should be minimized in order to increase the density of the dot pitch formed on the surface of the recording paper surface. As shown in FIGS. 2A and 2B, the head module 50′ according to the present embodiment has a structure in which a plurality of ink chamber units 53, each comprising a nozzle 51 forming an ink droplet ejection port, a pressure chamber 52 corresponding to the nozzle 51, and the like, are disposed two-dimensionally in the form of a staggered matrix, and hence the effective nozzle interval (the projected nozzle pitch) as projected in the lengthwise direction of the head (the main scanning direction perpendicular to the paper conveyance direction) is reduced and high nozzle density is achieved.

As shown in FIG. 2C, a head 50 having nozzle rows of a length corresponding to the full width of the recording paper 16 is formed by arranging and joining together, in a matrix configuration, the short head modules 50′ which are composed in this fashion. Furthermore, although not shown in the drawings, it is also possible to form a head by aligning short heads in a row.

An embodiment constituting one or more nozzle rows covering a length corresponding to the full width of the recording paper 16 in a direction substantially perpendicular to the paper conveyance direction is not limited to the present example. For example, rather than arranging a plurality of head modules 50′, it is also possible to form a long line head by a single head module 50′ which has the nozzle row structure shown in FIG. 2A.

The pressure chambers 52 which are provided to correspond to the nozzles 51 are formed with a substantially square planar shape and a nozzle 51 and an ink inlet port 54 are provided in the respective corner portions on a diagonal of this planar shape. The pressure chambers 52 connect with a common flow channel 55 via the ink inlet ports 54 respectively. Furthermore, the nozzle flow channels 60 connected to the pressure chambers 52 are each connected via individual flow channels 62 to a circulation common flow channel 64. A supply port 66 and an outlet port 68 are provided in each head module 50′, and the supply port 66 is connected to the common flow channel 55, while the output port 68 is connected to the circulation common flow channel 64.

In other words, a composition is achieved in which the supply port 66 and the outlet port 68 of each head module 50′ are connected via the ink flow channels (internal flow channels) including the common flow channel 55, the ink inlet ports 54, the pressure chambers 52, the nozzle flow channels 60, the individual flow channels 62 and the circulation common flow channel 64. Therefore, a portion of the ink supplied from outside the head module to the supply port 66 is ejected from each nozzle 51 and the remainder of the ink is discharged to the exterior of the head module from the outlet port 68 after passing sequentially through the common flow channel 55, the nozzle flow channels 60, the individual flow channels 62 and the circulation common flow channel 64 (in other words, after being circulated through the ink flow channels inside the head module).

A desirable composition is one where, as shown in FIG. 3, the individual flow channels 62 are connected to the nozzle flow channels 60 in the vicinity of the nozzles 51, because the ink is circulated near the nozzles 51 and therefore increase in the viscosity of the ink inside the nozzles 51 is prevented and stable ejection can be achieved.

Piezoelectric elements 58 each having an individual electrode 57 are bonded to the diaphragm 56 which constitutes a ceiling face of the pressure chambers 52 and also serves as a common electrode; a piezoelectric element 58 is deformed by applying a drive voltage to the individual electrode 57, thereby causing ink to be ejected from the corresponding nozzle 51. When ink is ejected, new ink is supplied to the pressure chamber 52 from the common flow channel 55 via the ink inlet port 54.

In the present embodiment, a piezoelectric element 58 is employed as an ejection pressure generating device for ink ejected from the nozzles 51 provided in the head modules 50′, but it is also possible to employ a thermal method in which a heater is provided inside each pressure chamber 52, and ink is ejected by using the pressure of film boiling produced by heating by the heater.

Furthermore, head temperature sensors 40 for measuring the temperature of the ink are provided for the respective head modules 50′ in the head 50. In the present embodiment, a thermistor is used for each head temperature sensor 40 and is disposed in the vicinity of the common flow channel 55; the sensor may measure the temperature of the head module 50′ which corresponds to the temperature of the ink inside the head module 50′, or may measure the temperature of the ink inside the head module 50′ directly.

As shown in FIG. 2B, the high-density nozzle head according to the present embodiment is achieved by arranging a plurality of ink chamber units 53 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 53 are arranged at a uniform pitch d in line with a direction forming an angle of θ with respect to the main scanning direction, the pitch P of the nozzles projected so as to align in the main scanning direction is d×cos θ, and hence the nozzles 51 can be regarded to be equivalent to those arranged linearly at a fixed pitch P along the main scanning direction. Such configuration results in a nozzle structure in which the nozzle row projected so as to be arranged in the main scanning direction has a high nozzle density of up to 2,400 nozzles per inch.

In implementing the present invention, the arrangement structure of the nozzles is not limited to the example shown in the drawings and it is possible to adopt various nozzle arrangement structures, such as a configuration having one nozzle row in the sub-scanning direction.

Furthermore, the scope of application of the present invention is not limited to a print method using a line type head, and the present invention may also be applied to a serial method in which printing is performed in the width direction of the recording paper 16 by employing a short head which is shorter than the length in the width direction (main scanning direction) of the recording paper 16 and performing a scanning action of the head in the width direction, and after completing one printing action in the width direction, the recording paper 16 is moved by a prescribed amount in a direction (sub-scanning direction) perpendicular to the width direction, printing in the width direction of the recording paper 16 is performed on the next print region, and by repeating this operation, printing is performed over the whole surface of the print area of the recording paper 16.

### Ink Supply System

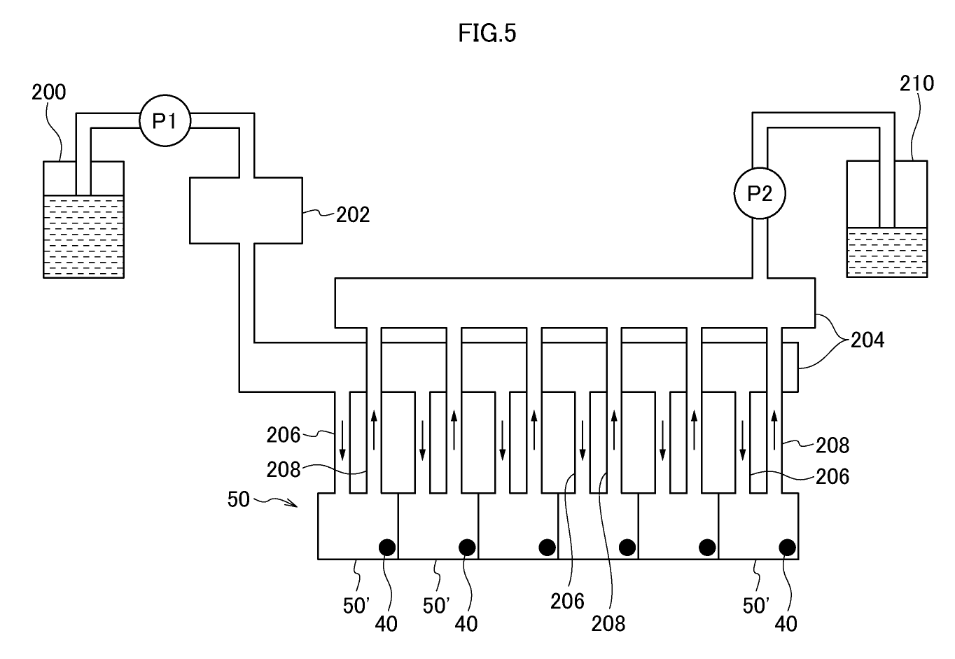

FIG. 5 is a schematic drawing showing the composition of an ink supply system of the inkjet recording apparatus 100. As shown in FIG. 5, the inkjet recording apparatus 100 includes, as an ink supply system, an ink supply tank 200, a supply pump P1, a temperature adjustment unit 202, a manifold 204, a recovery pump P2 and an ink recovery tank 210.

The ink supply tank 200 is a base tank which supplies ink to the head 50. The ink supply tank 200 may employ a mode where ink is replenished via a replenishment port (not illustrated) when the remaining amount of ink has become low, or a cartridge system where each tank is replaced individually. If the type of ink is changed in accordance with the usage, then a cartridge system is suitable. In this case, desirably, information about the ink type is identified by a barcode, or the like, and ejection is controlled in accordance with the type of ink.

The supply pump P1 is a pump for supplying ink inside the ink supply tank 200 to the manifold 204. Furthermore, a temperature adjustment unit 202 is provided between the supply pump P1 and the manifold 204. The temperature adjustment unit 202 is a heater and cooler for adjusting the temperature of the ink on the basis of the output values of the temperature sensors 40, in such a manner that the ink supplied to the manifold 204 assumes a prescribed temperature.

The manifold 204 distributes the ink supplied from the ink supply tank 200 to the respective head modules 50′, and the manifold 204 and the supply ports 66 of the head modules 50′ are connected via supply channels 206. The ink supplied to the manifold 204 by the supply pump P1 is distributed to the respective head modules 50′ via the supply channels 206.

The recovery pump P2 is a pump which recovers, via the manifold 204 and the outlet ports 68, ink that has been supplied from the supply ports 66 to the head modules 50′. The outlet ports 68 of the head modules 50′ and the manifold 204 are connected via outlet channels 208, and the ink supplied to the head modules 50′ is recovered into the ink recovery tank 210 via the outlet ports 68, the outlet channels 208, and the manifold 204.

The ink recovery tank 210 is a tank for storing ink that has been recovered by the recovery pump P2. Another possible mode is one where a circulation path is formed by sending the ink that has been recovered into the recovery tank 210, to the ink supply tank 200 via a circulation device, which is not illustrated.

### Configuration of Control System

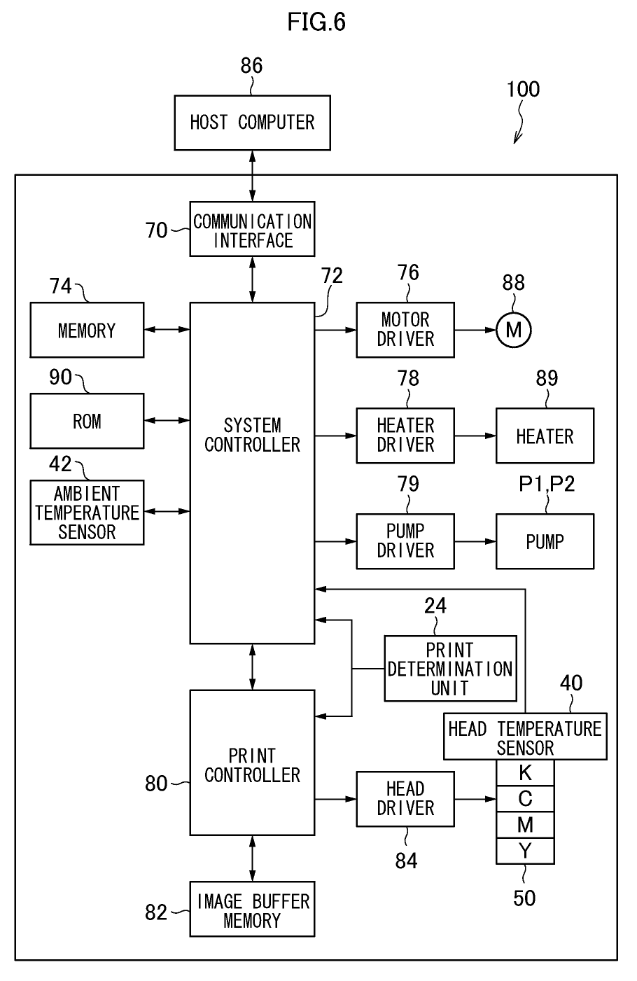

FIG. 6 is a principal block diagram showing a control system of the inkjet recording apparatus 100. The inkjet recording apparatus 100 comprises a communication interface 70, a system controller 72, a memory 74, a motor driver 76, a heater driver 78, a print controller 80, an image buffer memory 82, a head driver 84, and the like.

The communication interface 70 is an interface unit for receiving image data sent from a host computer 86. A serial interface such as USB (Universal Serial Bus), IEEE1394, Ethernet (trademark), wireless network, or a parallel interface such as a Centronics interface may be used as the communication interface 70. A buffer memory (not shown) may be mounted in this portion in order to increase the communication speed.

The image data sent from the host computer 86 is received by the inkjet recording apparatus 100 through the communication interface 70, and is temporarily stored in the memory 74. The memory 74 is a storage device for temporarily storing images inputted through the communication interface 70, and data is written and read to and from the memory 74 through the system controller 72. The memory 74 is not limited to a memory composed of semiconductor elements, and a hard disk drive or another magnetic medium may be used.

The system controller 72 is a control unit which controls the respective units of the communication interface 70, the memory 74, the motor driver 76, the heater driver 78, and the like. The system controller 72 is constituted by a central processing unit (CPU) and peripheral circuits, and the like, and controls communications with the host computer 86, and reading and writing of data from and to the memory 74, as well as generating control signals to control the motors 88 of the conveyance system and heaters 89.

Programs executed by the CPU of the system controller 72 and the various types of data which are required for control procedures are stored in the memory 74. The memory 74 may be a non-writeable storage device, or it may be a rewriteable storage device, such as an EEPROM. The memory 74 is used as a temporary storage region for the image data, and it is also used as a program development region and a calculation work region for the CPU.

The motor driver (drive circuit) 76 drives the motor 88 in accordance with commands from the system controller 72. The heater driver (drive circuit) 78 drives the heater 89 of the respective units, such as the post-drying unit and the like, in accordance with commands from the system controller 72. The pump driver 79 is a driver which drives the pumps P1 and P2 of the ink supply system in accordance with instructions from the system controller 72.

The print controller 80 has a signal processing function for performing various tasks, compensations, correction and other types of processing for generating print control signals from the image data stored in the memory 74 in accordance with commands from the system controller 72 so as to supply the generated print control signals (dot data) to the head driver 84. Required signal processing is carried out in the print controller 80, and the ejection amount and the ejection timing of the ink droplets from the respective print heads 50 are controlled via the head driver 84, on the basis of the image data (print data). By this means, desired dot size and dot positions can be achieved.

The print controller 80 is provided with the image buffer memory 82; and image data, parameters, and other data are temporarily stored in the image buffer memory 82 when image data is processed in the print controller 80. The aspect shown in FIG. 6 is one in which the image buffer memory 82 accompanies the print controller 80; however, the memory 74 may also serve as the image buffer memory 82. Also possible is an aspect in which the print controller 80 and the system controller 72 are integrated to form a single processor.

The head driver 84 generates drive signals for driving the piezoelectric elements 58 (see FIG. 3) of the heads 50 of the respective colors, on the basis of dot data supplied from the print controller 80, and supplies the generated drive signals to the piezoelectric elements 58. The head driver 84 may also incorporate a feedback control system for maintaining uniform drive conditions of the heads 50.

Head temperature sensors 40 for measuring the temperature of the ink are provided for the respective head modules 50′ in the head 50. The measurement results of the head temperature sensors 40 are input to the system controller 72 and used for various control procedures, such as controlling the temperature adjustment unit 202 (see FIG. 5).

The ambient temperature sensor 42 serves to measure the ambient temperature of the environment where the inkjet recording apparatus 100 is located, and is provided in a position avoiding the various sources of heat in the apparatus. The ambient temperature sensor 42 uses a platinum temperature sensing element, for instance, which has higher accuracy than the head temperature sensors 40, and the measurement result therefrom is input to the system controller 72.

The ambient temperature sensor 42 may be provided externally to the inkjet recording apparatus 100. In this case, a composition is adopted whereby the measurement results of the ambient temperature sensor 42 can be acquired by the system controller 72.

The system controller 72 performs calibration of the head temperature sensors 40 on the basis of the measurement results of the ambient temperature sensor 42. The details of the calibration of the head temperature sensors 40 are described hereinafter.

The print determination unit 24 is a block that includes the in-line sensor 190, reads the image printed on the recording medium 124, determines the print conditions (presence of the ejection, variation in the dot formation, and the like) by performing required signal processing, and the like, and provides the determination results of the print conditions to the print controller 80.

According to requirements, the print controller 80 makes various corrections with respect to the head 50 on the basis of information obtained from the print determination unit 24.

Control programs of various types are stored in the ROM 90, and the control programs are read out and executed in accordance with instructions from the system controller 72. The program storage unit 290 may employ a semiconductor memory, such as a ROM or EEPROM, or may use a magnetic disk, or the like. An external interface may be provided and a memory card or PC card may be used. Of course, it is also possible to provide a plurality of recording media, of these recording media. The ROM 90 may also serve as a recording device (not illustrated) for operating parameters, and the like.

### Calibration of Head Temperature Sensors

Next, the method of calibrating the head temperature sensors 40 will be described. The temperature of the ink, in other words, the internal temperature of the head 50, needs to be measured with high precision in order to guarantee ejection characteristics and prevent condensation on the nozzle surface. However, it is not possible to use a high-precision sensor for the head temperature sensors 40 due to the restrictions on the arrangement location and cost issues. Therefore, it is necessary to enable highly precise temperature measurement by calibrating the head temperature sensors 40.

The head temperature sensors 40 are calibrated by using correction coefficients calculated on the basis of the measurement value of the ambient temperature sensor 42. The correction coefficients used for the calibration are desirably calculated in advance and stored before the inkjet recording apparatus 100 is shipped.

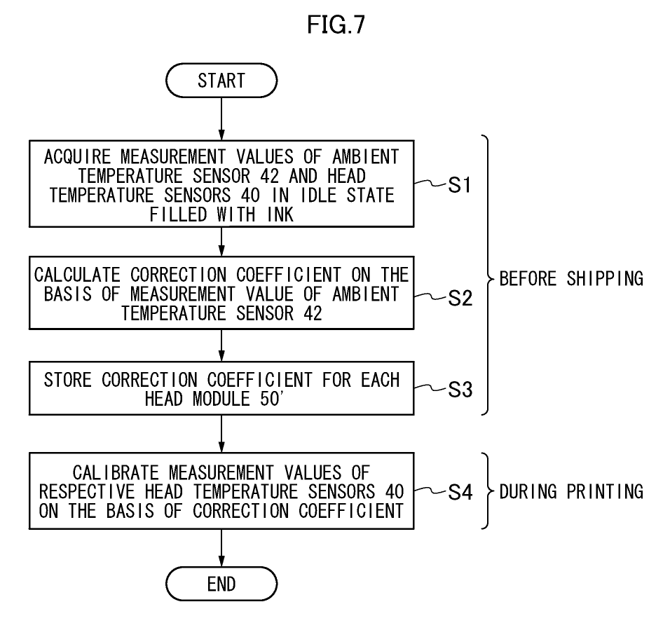

FIG. 7 is a flowchart showing a calibration process for a head temperature sensor 40.

Firstly, ink is filled into the head 50 (the respective head modules 50′), and the measurement values of the head temperature sensors 40 of the respective head modules 50′ are acquired in an idle state (where no ink is being circulated and no ejection of ink is performed). Furthermore, the ambient temperature in which the head 50 is situated is measured by the ambient temperature sensor 42 (step S1).

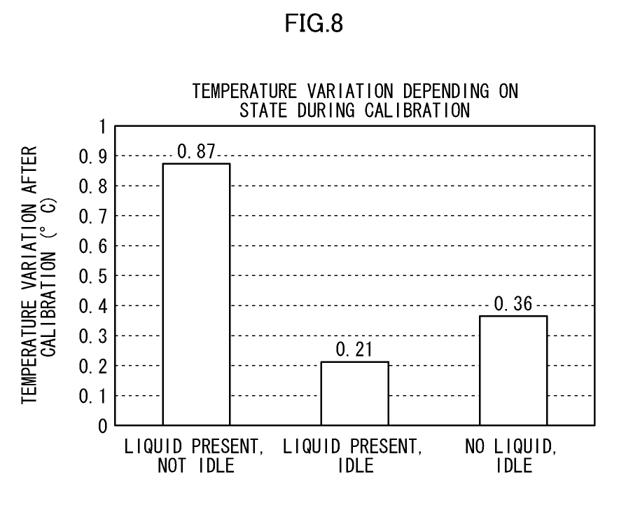

FIG. 8 is a graph showing the relationship between the internal state of each head modules 50′ when the measurement values of the head temperature sensor 40 of each head module 50′ are acquired, and the temperature variation after calibration. As shown in FIG. 8, when the head temperature sensors 40 were calibrated using measurement values taken in a state where the head modules 50′ were filled with ink and the ink was circulated, then the temperature variation after calibration was 0.87° C. On the other hand, when the head temperature sensors 40 were calibrated using measurement values taken with the head modules 50′ filled with ink and in an idle state, the temperature variation after calibration was 0.21° C. The reason why the variation after calibration was larger when ink was circulated in this way is thought to be because a temperature gradient is produced inside the manifold 204 by the circulation of ink and therefore stable measurement values cannot be acquired.

Furthermore, in a state where the head was not filled with ink (an idle state where no ink was present and therefore, naturally, no ink was circulated), the temperature variation after calibration was 0.36° C. If the head is not filled with ink, then the thermal capacity of the head modules 50′ becomes lower, and therefore acquisition of measurement values of the head temperature sensors 40 becomes instable, compared to an idle state where the head modules are filled with ink.

In this way, the inventor has discovered that the optimal state for acquiring measurement values for calibrating the temperature sensors is an idle state where the head is filled with ink. Consequently, in the present embodiment, the measurement values of the head temperature sensors 40 are taken with the head filled with ink and in an idle state.

Next, a correction coefficient for each head temperature sensor 40 is calculated on the basis of the measurement value of the ambient temperature sensor 42 (step S2).

In order to calculate the correction coefficient, firstly, a reference value G0 for the resistance value of a head temperature sensor 40 for which the correction coefficient is determined is calculated. G0 is calculated by the following equation (Formula 1), taking the measurement value of the ambient temperature sensor 42, which is a reference value, to be T.

G0=C2×T²+C1×T+C0 [unit: 1/kΩ] Formula 1

Here, C2 to C0 are selected from Table 1 below on the basis of the positive temperature (the measurement value T of the ambient temperature sensor 42). The coefficients shown in Table 1 are coefficients obtained by approximating the characteristics of the thermistors used in the head temperature sensors 40, in each temperature range.

TABLE 1

| T | C2 | C1 | C0 |
|---|---|---|---|
| Less than 22.5° C. | 5 × 10⁻⁵ | 1 × 10⁻³ | 4 × 10⁻² |
| 22.5° C. or above and | 6 × 10⁻⁵ | 7 × 10⁻⁴ | 4 × 10⁻² |
| less than 27.5° C. | | | |
| 27.5° C. or above and | 7 × 10⁻⁵ | 3 × 10⁻⁴ | 5 × 10⁻² |
| less than 32.5° C. | | | |
| 32.5° C. or above and | 8 × 10⁻⁵ | −3 × 10⁻⁴ | 6 × 10⁻² |
| less than 37.5° C. | | | |
| 37.5° C. or above | 9 × 10⁻⁵ | −1 × 10⁻³ | 8 × 10⁻² |

Next, taking the temperature for calibration (the temperature to be subject to calibration) to be Ts, the reciprocal F of the measured resistance value of the head temperature sensors 40 is calculated by Formula 2 below.

F=C2×Ts²+C1×Ts+C0 [unit: 1/kΩ] Formula 2

G=((4095/D)−1)/6.2−1/1000)×A [unit: 1/kΩ] Formula 3

If this coefficient G is used, then the temperature T after final calibration is expressed by Formula 4 below.

T=B2×G²+B1×G+B0 [unit: ° C.] Formula 4

Here, B2 to B0 are selected from Table 2 below, on the basis of the target temperature Th (the measurement value T of the ambient temperature sensor 42) of the head modules 50′.

TABLE 2

| Head target | | | |
|---|---|---|---|
| temperature Th | B2 | B1 | B0 |
| Less than 22.5° C. | −1600 | 600 | −20 |
| 22.5° C. or above and | −1200 | 500 | −10 |
| less than 27.5° C. | | | |
| 27.5° C. or above and | −800 | 400 | −10 |
| less than 32.5° C. | | | |
| 32.5° C. or above and | −600 | 400 | −10 |
| less than 37.5° C. | | | |
| 37.5° C. or above | −400 | 300 | −2 |

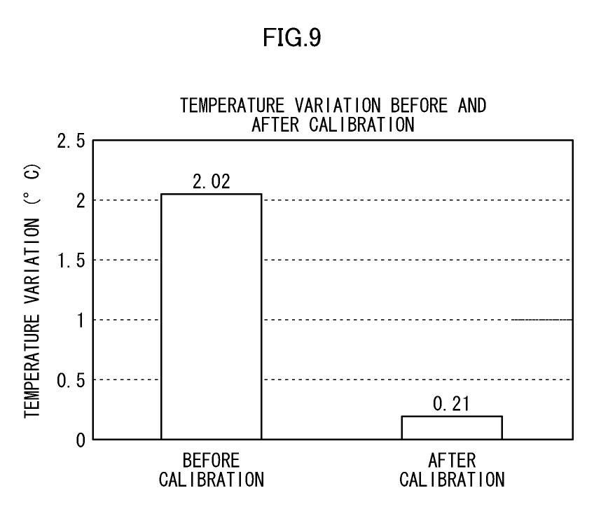

As a result of performing calibration of the head temperature sensors 40 as described above, the temperature variation which was 2.02° C. before calibration as shown in FIG. 9 became 0.21° C. after calibration. By calibrating the head temperature sensors 40 with reference to the ambient temperature sensor 42 in this way, it is possible to measure the temperature inside the head modules 50′ with good accuracy.

As a result of this, it becomes possible to monitor accurately the temperature distribution within a long line head, and print defects caused by temperature distribution abnormalities can be detected in advance. A composition can be adopted in which if a temperature distribution abnormality is detected, then a report is issued to the user from the host computer 86, via the communication interface 70.

In the head 50 according to the present embodiment, the ink is circulated in the vicinity of the nozzles 51 by circulating the ink through flow channels inside the head, but the head 50 is not limited to a mode where the ink is circulated, and the ink flow channels may also terminate at the nozzles 51. In a head having a composition of this kind, the measurement values of the head temperature sensors 40 are desirably acquired by filling the head with ink and setting to an idle state in which ink is not ejected from the nozzles 51.

### Feedback Control of Temperature Measurement Values for Each Head Module

By calibrating the temperature sensors in the respective head modules, it becomes possible to monitor the temperature distribution in a line head accurately, and therefore feedback control of various kinds can also be implemented on the basis of the determined temperature distribution.

For example, the ejection rate of each head module 50′ may be changed on the basis of the temperature measurement values after calibration of the each temperature sensor 40.

As stated previously, if there is a change in the temperature of the ink, then the viscosity of the ink changes and as a result of this, the ink ejection characteristics vary. Therefore, by changing the drive signal for driving the piezoelectric elements 58 in each head module 50′, in accordance with the measured temperature of each head temperature sensor 40, it is possible to use a drive signal that is suitable to the temperature of the ink in each head module 50′, and therefore the nozzles 51 eject liquid droplets of the same volume at all times, regardless of the temperature of the ink, and optimal print quality can be maintained, regardless of the temperature distribution.

The change in the drive signal can involve changing the amplitude of the signal. For example, by referring to the table which records temperatures and the corresponding optimal amplitude of the drive signal at those temperatures, optimal amplitude can be acquired on the basis of the measurement temperature after calibration of the head temperature sensors 40, and a drive signal of the amplitude thus acquired should be output.

The drive signal can also be changed by altering the signal width. In this case also, driving is controlled by using a table which records temperatures and the corresponding optimal signal widths of the drive signal at those temperatures.

In this way, it is possible to change the ejection rate for each head module 50′ in accordance with the measurement temperatures of the respective head temperature sensors 40.

### Adjustment for Each Head Module

By controlling the temperature of the ink in each head module 50′ on the basis of the temperature distribution inside the line head, it is possible to reduce the temperature distribution in the head and consequently to improve the print quality.

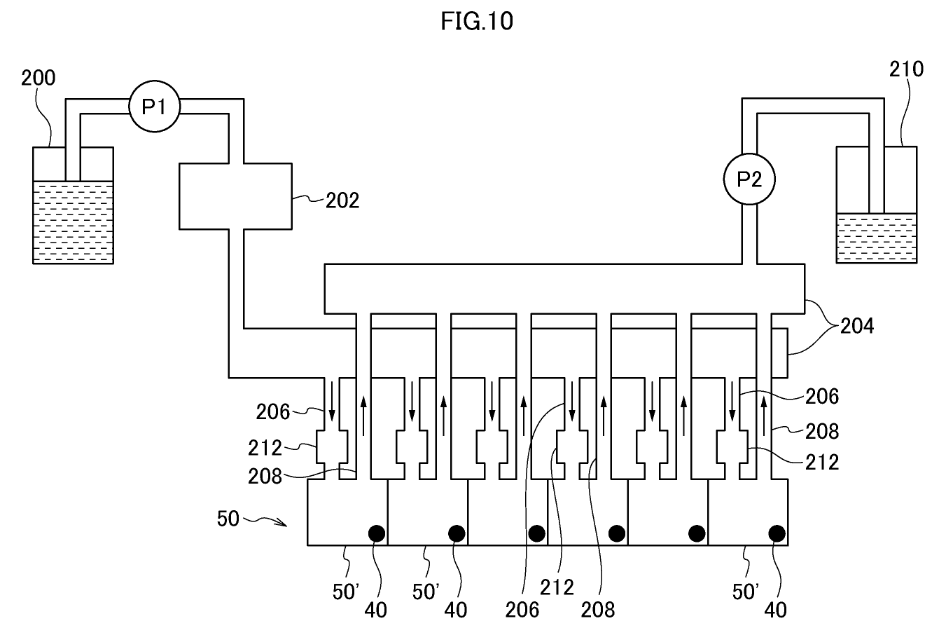

FIG. 10 is a schematic drawing showing the composition of an ink supply system including individual temperature adjustment units 212 provided in the supply channels 206 respectively.

The individual temperature adjustment units 212 are heaters/coolers for respectively adjusting the temperature of the ink supplied to the respective head modules 50′ via the supply channels 206. The system controller 72 controls the individual temperature adjustment units 212 in such a manner that the temperature of each head module 50′ is uniform, on the basis of the output values of each head temperature sensor 40.

By adjusting the temperature in each of the head modules 50′ in this way, it is possible to reduce the temperature distribution in the head 50 and improvement in print quality such as reduction of the non-uniformity can be achieved.

### Temperature Adjustment for Each Head Module Using an Electromagnetic Valve

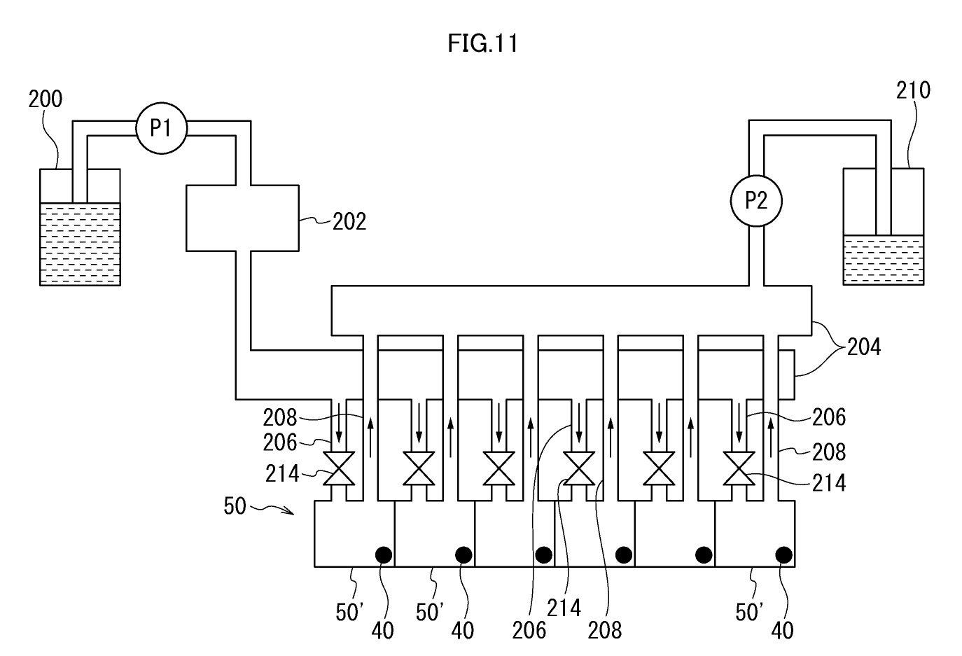

It is also possible to adjust the temperature of the ink by means of an electromagnetic valve, instead of an individual temperature adjustment unit 212. FIG. 11 is a schematic drawing showing the composition of an ink supply system including electromagnetic valves 214 provided in the supply channel 206 respectively.

The electromagnetic valves 214 are valve devices capable of opening and closing the supply channels 206, and open and close in accordance with the power applied by the system controller 72. Ink flows into the head modules 50′ from the manifold 204 and via the supply channels 206 when the electromagnetic valves 214 are opened, and this ink flow is shut off when the electromagnetic valves 214 are closed.

The system controller 72 can apply power to the electromagnetic valves 214 so as to open and close the electromagnetic valves 214, and apply a power different to that required for the opening and closing of the electromagnetic valves 214 to the electromagnetic valves 214 so as to adjust the temperature of the electromagnetic valves 214. There is no particular restriction on the type of electromagnetic valves 214, which may be normally open, normally closed or latch type valves.

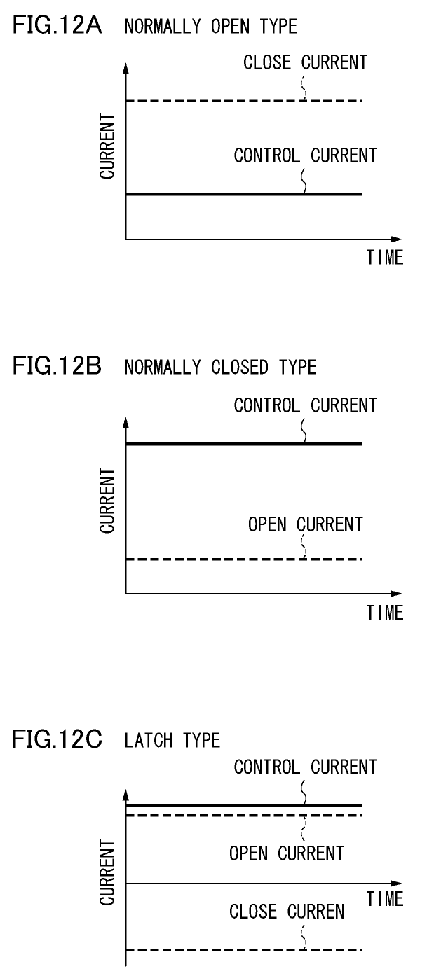

FIGS. 12A to 12C are waveform diagrams showing one example of the current (control current) applied to an electromagnetic valve 214. FIG. 12A shows a control current applied when the electromagnetic valve 214 is a normally open type. A normally open type of electromagnetic valve 214 is set to an open state when no current is applied, and is set to a closed state where a current required for closing the electromagnetic valve 214 (close current) is applied. Therefore, by applying a control current which is smaller than the close current to an electromagnetic valve 214, it is possible to adjust the electromagnetic valve 214 in an open state to a prescribed temperature.

FIG. 12B shows a control current applied when an electromagnetic valve 214 is a normally closed type. A normally closed type of electromagnetic valve 214 is set to a closed state when no current is applied, and is set to an open state when a current required for opening the electromagnetic valve 214 (open current) is applied. Therefore, it is possible to adjust the electromagnetic valve 214 in an open state to a prescribed temperature, by applying a control current which is greater than the open current.

FIG. 12C shows a control current applied when an electromagnetic valve 214 is a latch type. The latch type electromagnetic valve 214 is set to an open state when an open current is applied and is set to a closed state when a close current is applied. In the example shown in FIG. 12C, the open current is greater than the close current, and a control current greater than the open current is applied to the electromagnetic valve 214. If the open current is greater than the close current in this way, then it is possible to adjust the electromagnetic valve 214 in an open state to a prescribed temperature by applying a control current greater than at least the close current to the electromagnetic valve 214.

Although not shown in the drawings, when a latch type electromagnetic valve 214 is used, then if the open current is smaller than the close current, it is possible to adjust the electromagnetic valve 214 in an open state to a prescribed temperature by applying a control current smaller than at least the close current to the electromagnetic valve 214.

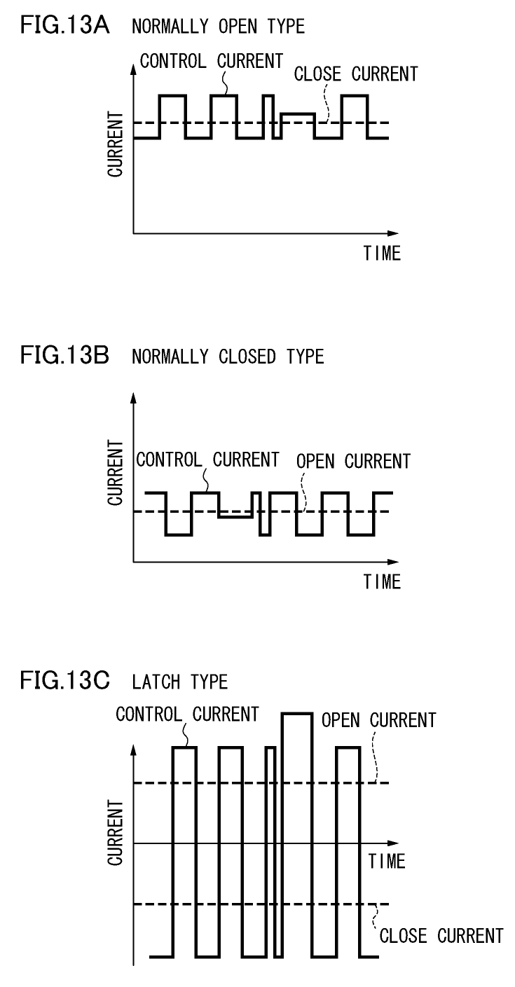

FIGS. 13A to 13C are waveform diagrams showing a further example of the control current applied to an electromagnetic valve 214. FIGS. 13A, 13B and 13C respectively show the control current applied when using an electromagnetic valve 214 of a normally open type, a normally closed type and a latch type. As shown in these diagrams, by applying a pulse type control current which varies above and below the close current or the open current, it is possible to open and close the electromagnetic valve 214 intermittently and vary the current applied during intermittent operation, and the intermittent period, appropriately. In this case also, it is possible to adjust the temperature of the electromagnetic valve 214 in a similar manner to the example shown in FIGS. 12A to 12C.

In this way, the temperature of the electromagnetic valve 214 can be adjusted by applying a control current corresponding to the type of the electromagnetic valve 214 (norm ally open, normally closed or latch type valve), to the electromagnetic valve 214. Therefore, by adjusting the temperature of each electromagnetic valve 214 in accordance with the measurement value of each head temperature sensor 40, the system controller 72 is able to adjust the temperature of the ink passing through the respective electromagnetic valves 214, in other words, the ink supplied to the respective head modules 50′ via the supply channels 206, to a desired temperature, and hence the temperature variation between the head modules 50′ can be reduced.

In the examples shown in FIGS. 12A to 12C and FIGS. 13A to 13C, the temperature of the electromagnetic valves 214 is adjusted by controlling the current applied to the electromagnetic valves 214, but the invention is not limited to this and it is also possible to control the voltage applied to the electromagnetic valves 214. Furthermore, the control method is not limited to one based on direct current and it is also possible to use a control method based on alternating current.

### Temperature Adjustment for Each Head Module by Flow Rate Adjustment

In the composition of an ink supply system shown in FIG. 11, it is possible to adjust the temperature of each head module 50′ by adjusting the flow rate using the electromagnetic valves 214.

An ink temperature distribution arises inside the manifold 204 and inside the head 50 as a result of the ambient temperature, and the like. Here, if the ink flow rate in a supply channel 206 which is connected to a certain head module 50′ is made smaller by the electromagnetic valve 214, then the time during which the ink flows through the supply channel 206, the head module 50′ and the outlet channel 208 becomes longer, and therefore the head module 50′ becomes more liable to be affected by the ambient temperature. Conversely, if the ink flow rate to a particular head module 50′ is increased, then the time during which the ink flows through the supply channel 206, the head module 50′ and the outlet channel 208 becomes shorter, and therefore the head module 50′ becomes less liable to be affected by the ambient temperature.

In this way, by altering the ink flow rate by means of each of the electromagnetic valves 214, it is possible to adjust the temperature of each head module 50′. By controlling each of the electromagnetic valves 214 on the basis of the measurement values of each head temperature sensor 40 so as to adjust the flow rate of the ink in each of the head modules 50′, the system controller 72 is able to reduce the temperature distribution in the head modules 50′ and achieve improvement in print quality such as the reduction of the non-uniformities.

### OTHER MODIFICATION EXAMPLES

The calculation of a correction coefficient for the head temperature sensors 40 may also be carried out in a state where the head 50 is not installed in the inkjet recording apparatus 100. In this case, a composition is desirably adopted in which the measurement values of the head temperature sensors 40 can be output to the exterior of the head 50 by the interface, which is not shown.

The measurement values of the head temperature sensors 40 are acquired in a state where the head 50 is filled with ink. Furthermore, simultaneously with this, a measurement value is acquired from a high-precision temperature sensor which measures the ambient temperature of the environment where the head 50 is located. The correction coefficients for each of the head temperature sensors 40 are calculated using Formula 1 to Formula 3 above, on the basis of the measurement value thus acquired. The correction coefficients thus calculated are desirably stored in a memory provided in the head 50, by using an interface which is not illustrated.

When the head 50 is subsequently installed in the inkjet recording apparatus 100, the system controller 72 of the inkjet recording apparatus 100 is able to correct the measurement values of the head temperature sensors 40 by reading out the correction coefficients for each head temperature sensor 40 stored in the memory of the head 50.

By adopting a composition of this kind, during the manufacture of the head 50, it is possible to calculate the correction coefficients of the head temperature sensors 40 of the head 50 in advance before the head is installed in the inkjet recording apparatus 100. Since the correction coefficients are stored in advance, then even if the head 50 of the inkjet recording apparatus 100 is changed for a new one, there is no need to wait until the state of the head 50 stabilizes and printing can be carried out using the new head 50 straight away.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method of calibrating a temperature sensor for measuring a temperature of a liquid in a recording head of an inkjet type having nozzles from which the liquid is ejected, the temperature sensor being provided in the recording head, the method comprising:
an ambient temperature acquisition step of acquiring an ambient temperature where the recording head is located;
a sensor output value acquisition step of acquiring an output value of the temperature sensor in a state where the liquid has been filled into the recording head;
a calculation step of calculating a correction coefficient for correcting the output value according to the ambient temperature and the output value; and
a storage step of storing the correction coefficient in a storage device of the recording head.

2. The method of calibrating a temperature sensor as defined in claim 1, wherein, in the sensor output value acquisition step, the output value of the temperature sensor is acquired in a state where ejection of the liquid is not being performed by the recording head.

3. The method of calibrating a temperature sensor as defined in claim 1, wherein:
the recording head includes a circulation flow channel for circulating the liquid, and
in the sensor output value acquisition step, the output value of the temperature sensor is acquired in a state where the liquid is not being circulated in the circulation flow channel.

4. An ink jet recording apparatus comprising:
a recording head of an inkjet type which includes nozzles from which a liquid is ejected and a temperature sensor for measuring a temperature of the liquid in the recording head;
an introduction device which introduces the liquid into the recording head;
a reservoir which connects with the introduction device via a liquid flow channel;
a liquid conveyance device which supplies the liquid from the reservoir to the recording head;
an ambient temperature acquisition device which acquires an ambient temperature where the recording head is located;
a sensor output value acquisition device which acquires an output value of the temperature sensor in a state where the liquid has been filled into the recording head;
a calculation device which calculates a correction coefficient for correcting the output value according to the ambient temperature and the output value;
a liquid temperature measurement device which acquires the output value of the temperature sensor and corrects the acquired output value according to the correction coefficient to calculate the temperature of the liquid in the recording head; and
a control device which controls the recoding head to cause the liquid to be ejected from the nozzles.

5. The inkjet recording apparatus as defined in claim 4, further comprising a storage device which stores the correction coefficient,
wherein when the control device causes the liquid to be ejected from the nozzles, the correction coefficient is stored previously in the storage device.

6. The inkjet recording apparatus as defined in claim 4, further comprising a judgment device which judges whether or not a temperature distribution of the liquid in the recording head is normal, wherein:
the recording head has the plurality of temperature sensors,
the liquid temperature measurement device calculates the temperature distribution of the liquid in the recording head according to the plurality of temperature sensors, and
the judgment device which judges whether or not the temperature distribution is normal, according to the temperature distribution calculated by the liquid temperature measurement device.

7. The inkjet recording apparatus as defined in claim 4, further comprising a temperature control device which controls the temperature of the liquid, wherein:
the recording head includes a plurality of modules each having the nozzles,
the plurality of temperature sensors are provided for the plurality of modules respectively, and
the temperature control device controls the temperature of the liquid with respect to each of the plurality of modules, according to the temperature of the liquid in each of the plurality of modules obtained from the plurality of temperature sensors provided for the plurality of modules respectively.

8. The inkjet recording apparatus as defined in claim 7, wherein:
the introduction device includes individual flow channels which introduce the liquid into the plurality of modules respectively, and
the temperature control device is a temperature adjustment device which heats and/or cools the liquid in the individual flow channels.

9. The inkjet recording apparatus as defined in claim 7, wherein:
the introduction device includes individual flow channels which introduce the liquid into the plurality of modules respectively and electromagnetic valves provided for the individual flow channels respectively, and
the temperature control device is an electromagnetic valve control device which causes the electromagnetic valves to heat the liquid.

10. The inkjet recording apparatus as defined in claim 7, wherein:
the introduction device includes individual flow channels which introduce the liquid into the plurality of modules respectively and a flow rate control device capable of controlling a flow rate of the liquid for each of the individual flow channels, and
the temperature control device causes the flow rate control device to control the flow rate of the liquid to makes the temperature distribution in each of the plurality of modules uniform.

11. The inkjet recording apparatus as defined in claim 4, further comprising an ejection rate modification device which modifies an ejection rate of the liquid from the nozzles, wherein:
the recording head includes a plurality of modules each having the nozzles, and the temperature sensors provided for the plurality of modules respectively, and
the ejection rate modification device modifies the ejection rate of the liquid from the nozzles with respect to each of the plurality of modules, according to the temperature of the liquid obtained from the temperature sensors provided for the plurality of modules respectively.

12. The inkjet recording apparatus as defined in claim 11, further comprising a drive signal generation device which generates a drive signal for ejecting the liquid from the nozzles,
wherein the ejection rate modification device modifies the drive signal with respect to each of the plurality of modules to modify the ejection rate, according to the temperature of the liquid obtained from the temperature sensors.

13. A method of manufacturing a recording head of an inkjet type including nozzles from which a liquid is ejected and a temperature sensor for measuring a temperature of the liquid in the recording head, the method comprising:
an ambient temperature acquisition step of acquiring an ambient temperature where the recording head is located;
a sensor output value acquisition step of acquiring an output value of the temperature sensor in a state where the liquid has been filled into the recording head;
a calculation step of calculating a correction coefficient for correcting the output value according to the ambient temperature and the output value; and
a storage step of storing the correction coefficient in a storage device of the recording head.
